(19) United States
(12) Patent Application Publication
(10) Pub. No.: US 2006/0032946 A1
(43) Pub. Date: Feb. 16, 2006

(54) Solution dispensing apparatus

(75) Inventors: Linda G. Cooper, Dallas, TX (US); George Carter, Garland, TX (US)

Correspondence Address: HAYNES AND BOONE, LLP, 901 MAIN STREET, SUITE 3100, DALLAS, TX, 75202, US

(73) Assignee: SheerEsque, Inc., Dallas, TX (US)

(21) Appl. No.: 11/202,389

(22) Filed: Aug. 11, 2005

Related U.S. Application Data
(60) Provisional application No. 60/665,063, filed on Mar. 24, 2005.
(60) Provisional application No. 60/600,528, filed on Aug. 11, 2004.

(51) Int. Cl. B05B 9/01; B05B 15/06; B05B 7/02

(52) U.S. Cl. 239/532; 239/526; 239/525

(57) ABSTRACT

An apparatus for use in self-tanning is provided. The apparatus includes a wand for dispensing a self-tanning solution to a user's body. The solution is contained in an aerosol container having a dispensing mechanism. The apparatus comprises a receiving means for attaching the aerosol container to the wand, and a triggering means coupled to the receiving means for actuating the dispensing mechanism. The triggering means includes a trigger configured for actuation by a user of the apparatus, an engagement mechanism configured for engaging and actuating the dispensing mechanism, and a linkage mechanism coupling the trigger mechanism to the engagement mechanism. Actuation of the trigger by the user results in actuation of the dispensing mechanism.

### RELATED APPLICATION DATA

This patent application claims the benefit of provisional U.S. Patent Application Ser. No. 60/665,063, filed Mar. 24, 2005, and provisional U.S. Patent Application Ser. No. 60/600,528, filed Aug. 11, 2004.

### BACKGROUND OF THE INVENTION

For the general population, embracing a more beautiful appearance is an every day occurrence. Looking great gives one the feeling of euphoric confidence. We have been enhancing our bodies for generations with make-up, and tanning in the sun to capture that same confident, radiant look.

In recent years, there has been emphasis on the harm that tanning in the sun can cause, in addition to the accelerated aging of the skin. Thus, there was a need for a better way to have a healthy suntanned appearance. Sunless tanning came to the marketplace, first as creams, lotions, and gels, applied by hand to the body, then misting the body by airbrush. Airbrush spray booths were created, and spa technician applied sunless tanning also came about in public locations. Aerosol containers able to dispense tanning solution are also available. A portable and hand held device would be invaluable for dispensing solution in difficult to reach areas.

For beauty that is safer, a second area that has also gained importance is cosmetics, moisturizers, and sunscreens. Cosmetics in the past have been liberally applied, laden with strong pigments. They were heavy with chemicals, drying and thick on the face. To aid in the quest to correct those situations, cosmetics have become less viscous with sunscreens and moisturizers added.

### BRIEF DESCRIPTION OF THE DRAWINGS

Aspects of the present disclosure are best understood from the following detailed description when read with the accompanying figures, in which:

FIGS. 1A and 1B are respective side sectional and top sectional views of an embodiment of an elongate wand formed by a partial sleeve that may be used in fabricating a solution dispensing apparatus;

FIG. 2 is a top view of an embodiment of an elongate wand that may be implemented in a hand-held solution dispensing apparatus;

FIG. 3 is a cross-sectional view of an embodiment of a frame comprising an elongate wand configured similar to wand shown in FIG. 2;

FIGS. 4A and 4B are a respective front view and isometric view of an embodiment of a trigger mechanism that may be used for fabrication of a solution dispensing apparatus;

FIGS. 5A and 5B are respective diagrammatic representations of an embodiment of an actuator and an actuator body element for providing a displacement force to a container in a solution dispensing apparatus;

FIG. 6 is a diagrammatic sectional view of an embodiment of an assembled self-tanning apparatus;

FIG. 7 is a diagrammatic representation of yet another embodiment of a solution dispensing apparatus featuring a compressed air dispensing mechanism;

FIG. 8 is a diagrammatic illustration of another embodiment of a solution dispensing apparatus featuring a siphon fluid compartment that operates as a solution feed tank;

FIG. 9 is a diagrammatic illustration of another embodiment of a solution dispensing apparatus that features a compressed air mechanism for fluid dispersion;

FIG. 10 is a diagrammatic illustration of another embodiment of a solution dispensing apparatus that features an extensible wand;

FIG. 11 is a diagrammatic illustration of another embodiment of a solution dispensing apparatus that features a telescoping wand;

FIGS. 12A and 12B are diagrammatic illustrations of another embodiment of a solution dispensing apparatus that features a folding handle;

FIG. 13A is a diagrammatic illustration of another embodiment of a solution dispensing apparatus featuring an integrated compressor;

FIG. 13B is a diagrammatic illustration of the solution dispensing apparatus of FIG. 13A configured for use in an airbrush assembly;

FIG. 14 is a diagrammatic representation of another embodiment of a solution dispensing apparatus that includes a nozzle integrated with the apparatus;

FIG. 15A is a diagrammatic representation of another embodiment of a solution dispensing apparatus that features an adjustable frame for receiving canisters of differing lengths and heights; and

FIG. 15B is a diagrammatic representation of the apparatus of FIG. 1SA having a canister loaded for solution dispensing.

### DETAILED DESCRIPTION

An apparatus described herein enables a user to achieve an even application of sunless tanning solution or cosmetics in the privacy of their home, as well as providing the advantage of portability while traveling.

The apparatus includes an elongate wand or other receiving means for receiving an aerosol container (e.g., a bottle) and provides a triggering means to actuate the release mechanism provided on the aerosol container to dispense the solution contained therein. The triggering means may be located at a distal end relative to the nozzle of the bottle, enabling the user to trigger the solution spray when the bottle is positioned to spray portions of the body that would otherwise be out of reach. For example, the apparatus enables the user to reach back over the shoulders to apply the solution to the upper back and a large portion of the torso, as well as applying the solution horizontally or vertically across the lower back and waist.

The apparatus is preferably constructed of a light-weight and sturdy material such as metal or plastic. The dimensions and profile of the apparatus are such that it is easy for the user to hold and manipulate.

In one embodiment, the apparatus' wand is sized to receive “off the shelf” aerosol containers. The apparatus is approximately ten to sixteen inches in length, one and one-half inches in diameter at the end containing the triggering means, and two and one-half inches in diameter at the end having the wand for receiving the aerosol container.

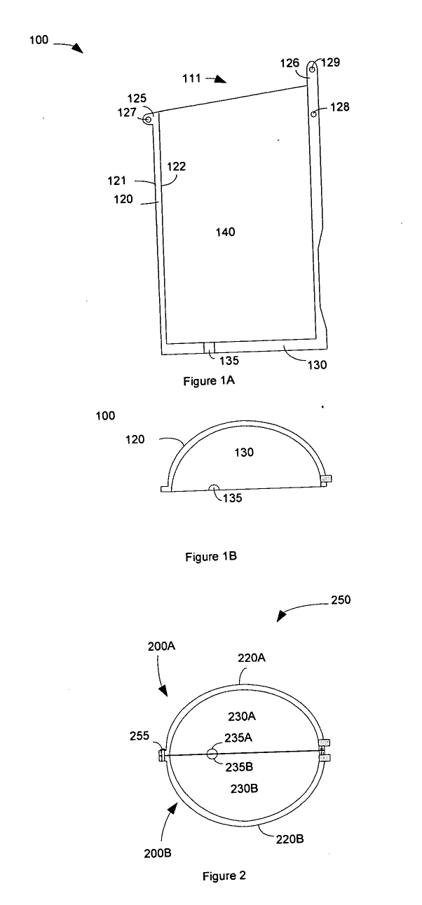

FIGS. 1A and 1B are respective side sectional and top sectional views of an embodiment of an elongate wand formed by a partial sleeve that may be used in fabricating a solution dispensing apparatus. A partial sleeve 100 comprises an elongate frame having a generally semi-circular cross section (as can be seen in the top sectional view of FIG. 1B). Sleeve 100 comprises a curved side wall 120 and a generally semicircular base 130. Sleeve 100 is open-ended to provide an opening 111 for receiving a container, such as an aerosol canister. Side wall 120 comprises an external surface 121 and an internal surface 122. An internal surface 122 is contoured to provide an elongate chamber or cavity 140 that functions as a receptacle for a canister. Base 130 preferably includes a slot 135 or other opening to allow for passage of an actuator mechanism therethrough as described more fully hereinbelow. Sleeve 100 may additionally include one or more flanges 125 or other features to facilitate connecting sleeve 100 with another similarly configured sleeve. For example, flange 125 may include a threaded aperture 127 for receiving a threaded fastener therein to facilitate connecting sleeve 100 with another similarly configured sleeve. Other features, such as threaded aperture 128, may similarly be disposed on sleeve 100 to facilitate secure coupling of complementary sleeves.

In accordance with embodiments described herein, a solution dispensing apparatus may comprise two complementary sleeves each implemented similar to sleeve 100 described in FIGS. 1A and 1B. For example, two sleeves generally configured according to sleeve 100 may be releasably coupled in a complementary fashion to provide a generally elongate cylindrical structure having a cylindrical cavity for receiving a container. Coupling of two sleeves may be had by any of various removable couplings, such as screws, latches, clamps, or other removable fasteners, such that the two sleeves are releasably attached.

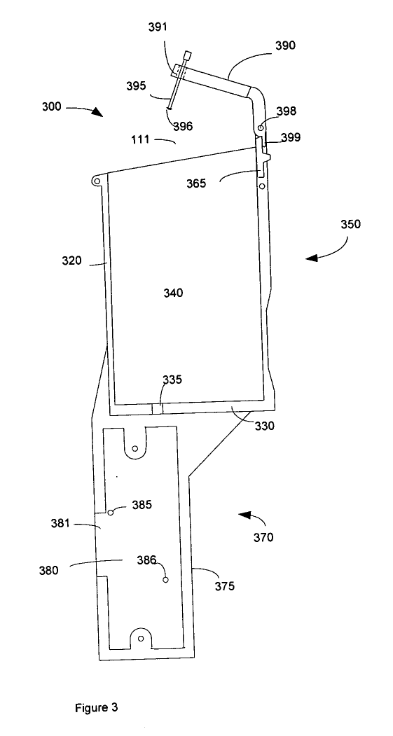

FIG. 2 is a top view of an embodiment of an elongate wand 250 that may be implemented in a hand-held self-tanning apparatus. Wand 250 may be fabricated from a complementary coupling of two sleeves 200A and 200B each generally configured similar to sleeve 100 shown and described in FIG. 1. In the illustrative example, sleeves 200A and 200B comprise respective side walls 220A and 220B and respective bases 230A and 230B (collectively referred to as base 230). Base 230 may preferably comprise a circular platform for support of a cylindrical aerosol container. Sleeves 200A and 200B are complementarily coupled by way of one or more screws 255 or other fasteners. Each of bases 230A and 230B may include a respective slot 235A and 235B or other opening that may be adjacently disposed within wand 250 when sleeves 200A and 200B are physically coupled to one another. Coupling of sleeves 200A and 200B provides a generally cylindrical cavity encompassed by side walls 220A and 220B and bases 230A and 230B. The cavity may be generally exposed at an end of wand 250 longitudinally opposite bases 230A and 230B.

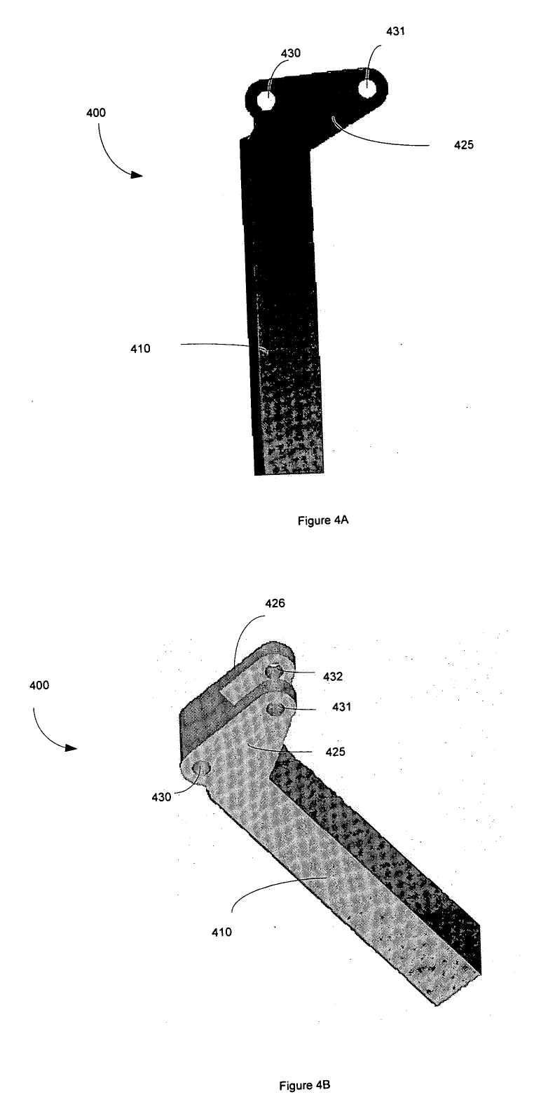

In accordance with a preferred embodiment, an elongate extension may be affixed to wand 250 to facilitate application of a self-tanning solution, a cosmetic solution, or other solution to a user. FIG. 3 is a cross-sectional view of an embodiment of a frame 300 comprising a wand 350 configured similar to wand 250 shown in FIG. 2. Wand 350 may be fabricated with two coupled sleeves configured as described above with reference to FIGS. 1A-2. Frame 300 comprises wand 350 comprising elongate side wall 320 and base 330. Side wall 320 and base 330 may be formed of two constituent complementary sleeves releasably coupled together as described above. Side wall 320 forms a cavity 340 for receiving a container, such as an aerosol canister. Frame 300 may comprise a handle 370 implemented as an elongate extension 375 that provides a mechanism for holding frame 300 and that may include an actuation mechanism for actuating a solution dispensing apparatus fabricated from frame 300. Handle 370 may include a recessed area 380 that provides a cavity within handle 370 for disposing an actuation mechanism. To this end, one or more fastening elements 385 and 386 may be included in recessed area 380. In the illustrative example, fastening element 385 may comprise a circular indention within recessed area 380, and fastening element 386 may comprise a pin. Additionally, recessed area 380 may comprise an opening 381 in a surface of elongate extension 375. Opening 381 may facilitate mounting and actuation of a trigger or other physically displaceable mechanism for engaging an actuation mechanism disposed in recessed area 380.

An elongate arm 390 may be integrated with or connected to sidewall 320 that provides a mechanism for mechanically depressing a trigger or other actuator of an aerosol container or other fluid dispenser. In the illustrative example, elongate arm 390 has an aperture 391, such as a threaded hole, through which a depression element 395 is coupled with elongate arm 390.

Depression element 395 may have a blunted distal end 396 that may be brought into abutment with a mechanical actuator of an aerosol container as described more fully below. In the illustrative example, depression element 395 is threadably affixed to elongate arm 390 via aperture 391. Thus, depression element 395 can be rotatably adjusted to selectively increase or decrease the extension of depression element 395. Elongate arm 390 may be rotatably coupled with sidewall 320 by, for example, a pin coupling 398. Additionally, elongate arm 390 may have a slender locking extension 399 that provides a mechanism for preventing elongate arm 390 from rotating, for example when an upward force is applied to depression element 395. In a preferred embodiment, a locking switch 365 is slideably engageable with locking extension 399. In a locked position, switch 365 is slid upward until in abutment with, or until a portion of switch 365 is adjacent to, locking extension 399. In this manner, elongate arm 390 is prevented from clockwise rotation. Switch 365 may be slid down until it is disengaged from extension 399. In this manner, elongate arm may be rotated clockwise such that a container may be placed in, or removed from, wand 350.

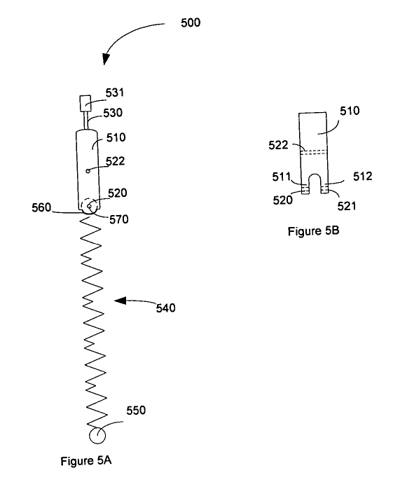

FIGS. 4A and 4B are a respective front view and isometric view of an embodiment of a trigger 400 mechanism that may be used for fabrication of a solution dispensing apparatus. Trigger 400 comprises a generally rectangular actuation member 410 and actuation flanges 425-426 disposed at an end of actuation member 410. An aperture 430 or other mounting element may be disposed at an end of actuation member 410. In the illustrative example, aperture 430 accommodates a mounting pin that is passed therethrough and engages fastening element 385 of handle 370 shown in FIG. 3. Particularly, a rotation coupling of actuation member 410 with handle 370 is provided by passing a mounting pin through aperture 430 into engagement with fastening element 385 of handle 370. Additionally, each of actuation flanges 425 and 426 may include aligned apertures 431 and 432 for coupling actuation flanges 425-426 with an actuator as described more fully below.

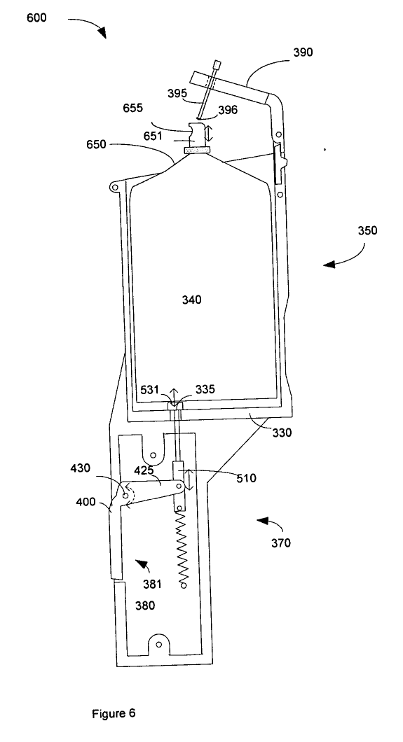

FIGS. 5A and 5B are respective diagrammatic representations of an embodiment of an actuator 500 (front view) and an actuator body element 510 (side view) for providing a displacement force to a container in a solution dispensing apparatus. Actuator 500 may comprise an actuator body element 510 that may include one or more mount elements 520-522. In the illustrative example, mount elements 520-522 comprise apertures. Additionally, body element 510 may include mount flanges 511-512. Mount flanges 511-512 facilitate reciprocal actuation of body element 510 as described more fully hereinbelow.

An extended member 530 and an elastic member 540 may be connected with body element 510 at opposing ends thereof. In the illustrative example, elastic member 540 may be implemented as a spring or other mechanism that generally facilitates reciprocal linear translation of body element 510 and consequent reciprocal translation of extended member 530.

A distal end of extended member 530 may have a cap 531 or other blunt implement for facilitating displacement of an aerosol container or other structure.

Elastic member 540 may have an annular member 560 for coupling elastic member 540 to body element 510. In the illustrative example, annular member 560 is interposed between mount elements 520-521. Accordingly, elastic member 540 may be coupled to body element 510 by, for example, a pin 570 that passes through mount element 520, annular member 560, and mount element 521. Additionally, elastic member 540 may have an annular member 550 disposed at an opposing end of elastic member 540 for coupling elastic member 540 with fastening element 386 of handle 370 shown in FIG. 3.

Mount element 522 may provide a coupling mechanism for coupling body element 510 with trigger 400 shown in FIGS. 4A and 4B. For example, body element 510 may be interposed between flanges 425 and 426 of trigger 400 such that mount element 522 is aligned with apertures 431-432. Accordingly, a pin or other device may be passed through apertures 431 and 432 of trigger 400 and through mount element 522 for rotatably coupling trigger 400 with body element 510.

A solution dispensing apparatus may be assembled from the above components generally according to the following. Trigger 400 is coupled with actuator 500 by a pin connector or other fastener. In the illustrative embodiment, trigger 400 is coupled to body element 510 of actuator 500 by passing a pin through apertures 431-432 of trigger and mount element 522, e.g., an aperture, of body element 510. Actuator 500 is coupled to frame 300 by a coupling of annular member 550 with fastening element 386 of handle 370. Actuator 500 is preferably positioned within frame 300 such that at least a portion of actuator 500 lies within a cavity 340 of frame 300. For example, actuator 500 may be positioned within frame handle 370 such that extended member lies within slot 335 and cap 531 is within cavity 340.

Actuator member 410 is positioned at least partially within opening 381 such that a surface thereof is exposed external to handle 370. Trigger 400 is rotatably coupled with handle 370 by a pin connector or other suitable fastener. For example, a pin may be passed through aperture 430 of trigger 400 and engage with mounting element 385 of handle 370.

The solution dispensing apparatus may then be assembled by coupling of two complementary apparatus halves each generally comprising complementary handles configured similar to handle 370 and complementary frames each generally configured similar to frame 300.

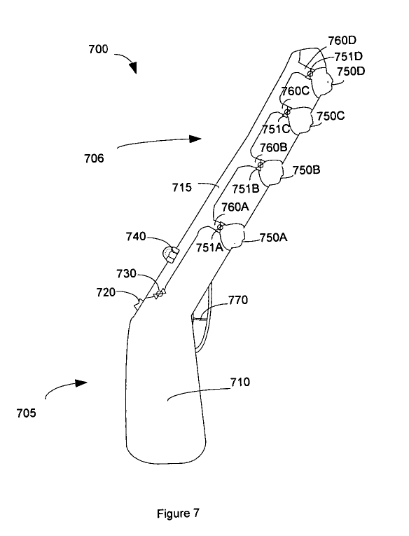

FIG. 6 is a diagrammatic sectional view of an embodiment of an assembled solution dispensing apparatus 600. An aerosol container 650 containing a solution, such as a self-tanning solution, a cosmetic solution, or other solution, may be inserted into wand 350 until it abuts base 330 (or cap 531). Elongate arm 390 and/or depression element 395 may be adjusted to accommodate aerosol containers of differing heights. In still other embodiments, the partial sleeves that form wand 350 may be adjustable to accommodate aerosol containers within cavity 340 of varying diameters. In some embodiments, aerosol container 650 may be secured in a manner that prevents it from rotating within cavity 340, thereby ensuring that a nozzle 655 of aerosol container 650 remains in a desired orientation.

Operation of solution dispensing apparatus 600 may be performed generally as follows. A user may grip apparatus by handle 370. The user may depress trigger 400 by, for example, exerting a force on the exposed surface of trigger 400 with a thumb, finger, or other part of the user's hand. In response to the user depressing trigger 400, trigger 400 is rotated in a counter clockwise direction about aperture 430 which results in a vertical displacement of flanges 425 and 426 of trigger 400. The vertical displacement of flanges 425 and 426 supplies a displacement force to body element 510 by way of a pin or other coupling of flanges 425 and 426 with body element 510 via mount element 522. Accordingly, a force is imparted on body element 510 that provides a vertical displacement to body element 510 and thus cap 531 of the actuator. Sufficient depression of trigger 400 results in abutment of cap 531 with container 650 and vertical displacement thereof. As container 650 is displaced upward within cavity 340, a depressible cap 651 of container 650 is abutted with distal end 396 of depressing element 395 resulting in depression of cap 651 such that fluid or other solution is ejected from nozzle 655.

It is understood that many different embodiments are contemplated for the described solution dispensing apparatus. For example, the wand may be formed using rings, clamps, straps, a full sleeve, or any other means or combination thereof for receiving and/or engaging a container of solution.

Furthermore, the apparatus may use many different types of triggering means.

Modifications may be made to the trigger, engagement mechanism, and/or linkage mechanism between the trigger and the engagement mechanism. For example, a squeezable ball or other air pressure device may be used to actuate the engagement mechanism to dispense the solution.

The apparatus may be further equipped with a telescoping extension to extend the reach of the apparatus. For example, the handle portion may be extendable. In other embodiments, the apparatus may be modular, with various user attachable modules to provide increased length, increased control over spraying direction, etc.

In some embodiments, the apparatus may be hinged to fold in half with the handle end of the apparatus folding into the wand where the aerosol container would be positioned.

In other embodiments, the handle end may be configured to fold toward the aerosol container in order to cover the container, thereby ensuring coverage of the nozzle and preventing the nozzle from dispensing fluid. This design may be used, for example, for convenience in leaving the container in place both for storage and for travel.

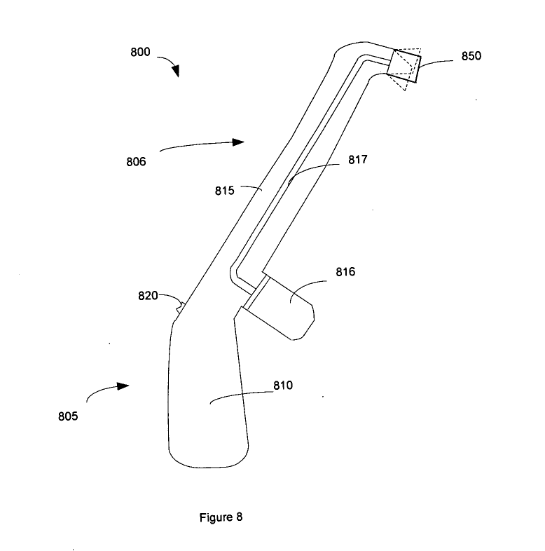

FIG. 7 is a diagrammatic representation of yet another embodiment of a solution dispensing apparatus 700 featuring a compressed air dispensing mechanism. Apparatus 700 may generally comprise a handle 705 and an elongate wand 706. In the illustrative example, handle 705 includes an air chamber 710 and wand 706 includes a fluid reservoir 715. A valve 730 or other suitable mechanism regulates the flow of air from chamber 710 into reservoir 715 thereby controlling the dispersal of fluid contained in reservoir 715. Preferably, value 730 is actuated by depression of a trigger 770. A switch 720 may be coupled with valve 730 for disabling and enabling apparatus 700. Reservoir 715 may include a cap 740 or other inlet through which reservoir 715 may be filled. Each of nozzles 750A-750D is coupled with reservoir 715 by way of respective ducts 760A-760D. Apparatus 700 incorporates multiple configurable airbrush nozzles 750A-750D for the purpose of evenly applying a sunless tanning solution, cosmetic solution, or another solution contained in reservoir 715 to the user's body. Because of its multi-nozzle design, apparatus 700 provides the user the ability to apply the solution in larger swaths and achieve even uninterrupted coverage. Additionally, each of nozzles 750A-750D may be respectively disabled so the nozzles through which solution is ejected is selectable. In the illustrative example, each of nozzles 750A-750D has a respective valve 751A-751D coupled therewith that may be manually engaged/disengaged thereby allowing the user to selectivity chose which nozzles 750A-750D solution will be dispersed from. In the illustrative example, chamber 710 is contained in an extension handle 705 of apparatus 700. Handle 705 enables the user to reach back over the shoulders to apply the solution to the upper back and a large portion of the torso, as well as applying the solution horizontally or vertically using large sweeping motion across the lower back and waist.

In operation, the user activates apparatus 700 by actuating trigger 770 that is coupled (mechanically, electrically, or by other means) to valve 730. When valve 730 opens, compressed air in chamber 710 enters reservoir 715 thereby driving fluid in reservoir 715 into ducts 760A-760D. Fluid under pressure from chamber air is then ejected through nozzles 750A-750D. In other embodiments, one or more of nozzles 750A-750D may be coupled with ducts 760A-760D by a ratcheting mechanism that allows the nozzle(s) to swivel to provide a better dispersion of fluid.

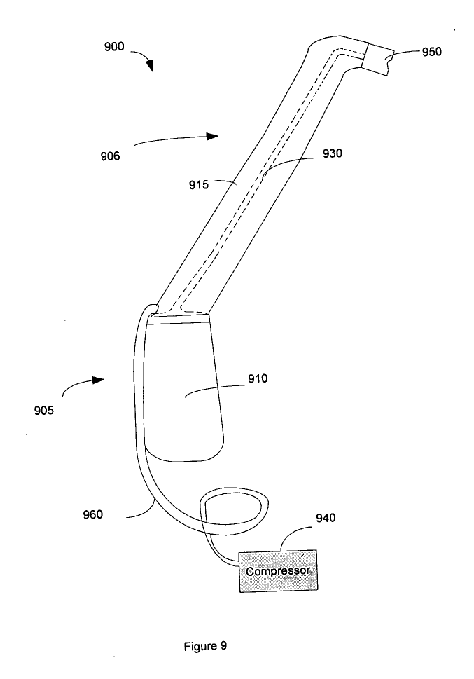

FIG. 8 is a diagrammatic illustration of another embodiment of a solution dispensing apparatus 800 featuring a siphon fluid compartment 816 that operates as a solution feed tank. Apparatus 800 may generally comprise a handle 805 and a wand 806. In the illustrative example, handle 805 includes an air chamber 810 and wand 806 includes a feed line 817 that connects compartment 816 with a nozzle 850. Apparatus 800 may feature a switch 820 for disabling and enabling apparatus 800. Compressed air from chamber 810 may be released into wand chamber 815 and drive fluid from compartment 816 through feed line 817 to be ejected from nozzle 850. Handle 805 enables the user to reach back over the shoulders to apply the solution to the upper back and a large portion of the torso, as well as applying the solution horizontally or vertically using large sweeping motion across the lower back and waist. Nozzle 850 may be coupled with wand 806 by a ratcheting mechanism that allows nozzle 850 to swivel to provide a better dispersion of fluid.

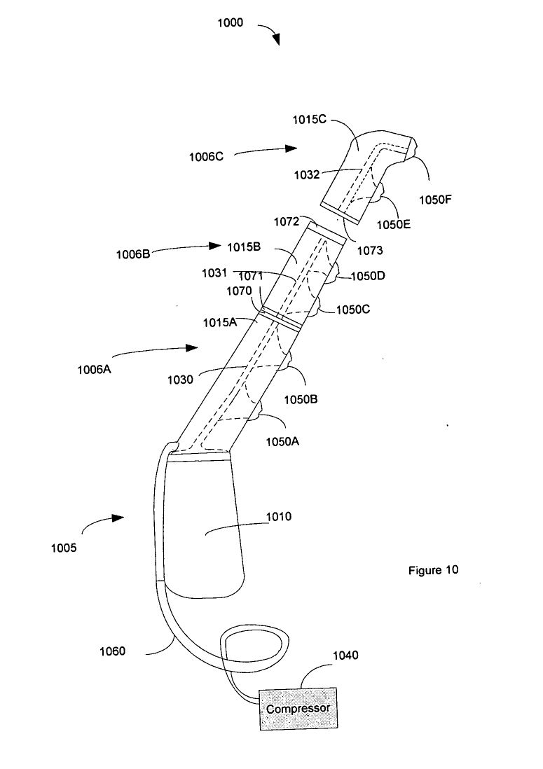

FIG. 9 is a diagrammatic illustration of another embodiment of a solution dispensing apparatus 900 that features a compressed air mechanism for fluid dispersion. Apparatus 900 generally comprises a handle 905 and an elongate wand 906. Handle 905 includes a reservoir 910 for holding a solution to be dispersed on a user. A compressor 940 is connected with apparatus 900 via a feed line 960 that directs compressed air into a chamber 915 within wand 906. When compressor 940 is actuated, compressed air entering chamber 915 forces solution in reservoir 910 into chamber 915 resulting in a fluid mix 930 comprising solution from reservoir 910 and air supplied from compressor 940. Solution is displaced through chamber 915 and ejected from a nozzle 950 on a distal end of wand 906.

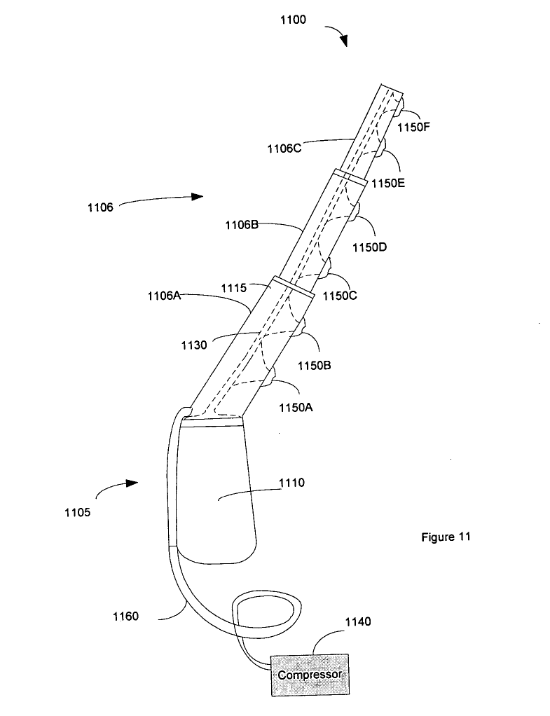

FIG. 10 is a diagrammatic illustration of another embodiment of a solution dispensing apparatus 1000 that features an extensible wand. Apparatus 1000 generally comprises a handle 1005 and one or more removably connectable wand segments 1006A-1006C (collectively referred to as wand 1006). Handle 1005 includes a reservoir 1010 for holding a solution to be dispersed on a user. A compressor 1040 is connected with apparatus 1000 via a feed line 1060 that directs compressed air into a chamber 105SA of a first wand segment 1006A that is attached to handle 1005. Wand 1006 may comprise one or more connectable wand segments 1006A-1006B. Each wand segment 1006A-1006C may include a respective chamber 1015A-1015C and one or more respective nozzles 1050A-1050F. Wand segments 1006A-1006B may be coupled at respective connectors 1070-1073. While exemplary apparatus 1000 is shown having three wand segments, apparatus 1000 may be implemented with any number of wand segments. Segments, such as wand segment 1006B, between a first wand segment, e.g., wand segment 1006A, and a final wand segment, e.g., wand segment 1006C, may comprise connectors 1071-1072 at opposing ends to facilitate coupling with multiple wand segments. When compressor 1040 is actuated, compressed air entering chamber 1015A forces solution contained within reservoir 1010 into chamber 1015A resulting in a fluid mix 1030 comprising solution from reservoir 1010 and air supplied from compressor 1040. Solution is displaced through chamber 1015A and ejected from a nozzle 1050A-1050B located on wand segment 1006A. When wand segment 1006B is coupled with wand segment 1006A, solution enters chamber 1015B from chamber 1015A and is ejected through nozzles 1050C and 1050D. In a similar manner, when additional segments 1006C are connected, solution enters chamber 1015C and is ejected from nozzles disposed thereon.

In the illustrative example, segments 1006A-1006C provide a chamber 1015 that is an aggregate of segment chambers 1015A-1015C thorough which solution from reservoir 1010 is driven. In other embodiments, each of segments 1006A-1006C may contain a respective reservoir from which solution is ejected from nozzles of the respective segments.

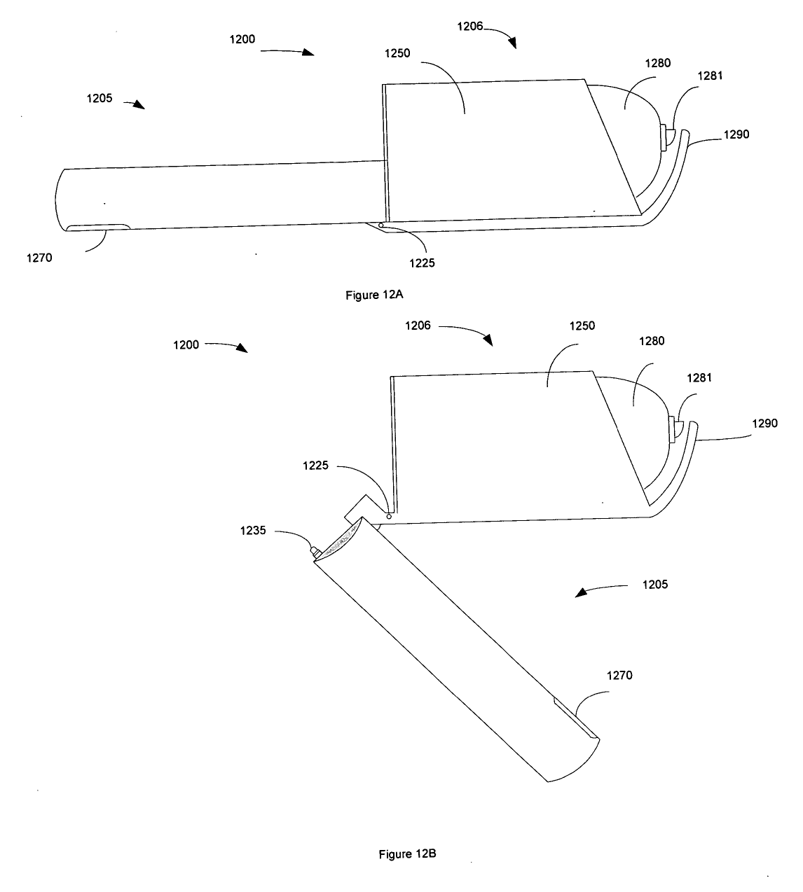

FIG. 11 is a diagrammatic illustration of another embodiment of a self-tanning apparatus 1100 that features a telescoping wand 1106. Apparatus 1100 generally comprises a handle 1105 and one or more telescoping wand segments 1106A-1106C (collectively referred to as wand 1106). Handle 1105 includes a reservoir 1110 for holding a solution to be dispersed on a user. A compressor 1140 is connected with apparatus 1100 via a feed line 1160 that directs compressed air into a chamber 1115 formed by wand segments 1106A-1106C. While exemplary apparatus 1100 is shown having three wand segments 1106A-1106C, apparatus 1000 may be implemented with any number of wand segments. When compressor 1140 is actuated, compressed air entering chamber 1115 forces solution contained in reservoir 1110 into chamber 1115 resulting in a fluid mix 1130 comprising solution from reservoir 1110 and air supplied from compressor 1140. Solution is displaced through chamber 1115 and ejected from one or more nozzles 1150A-1150F of wand segments 1106A-1106C.

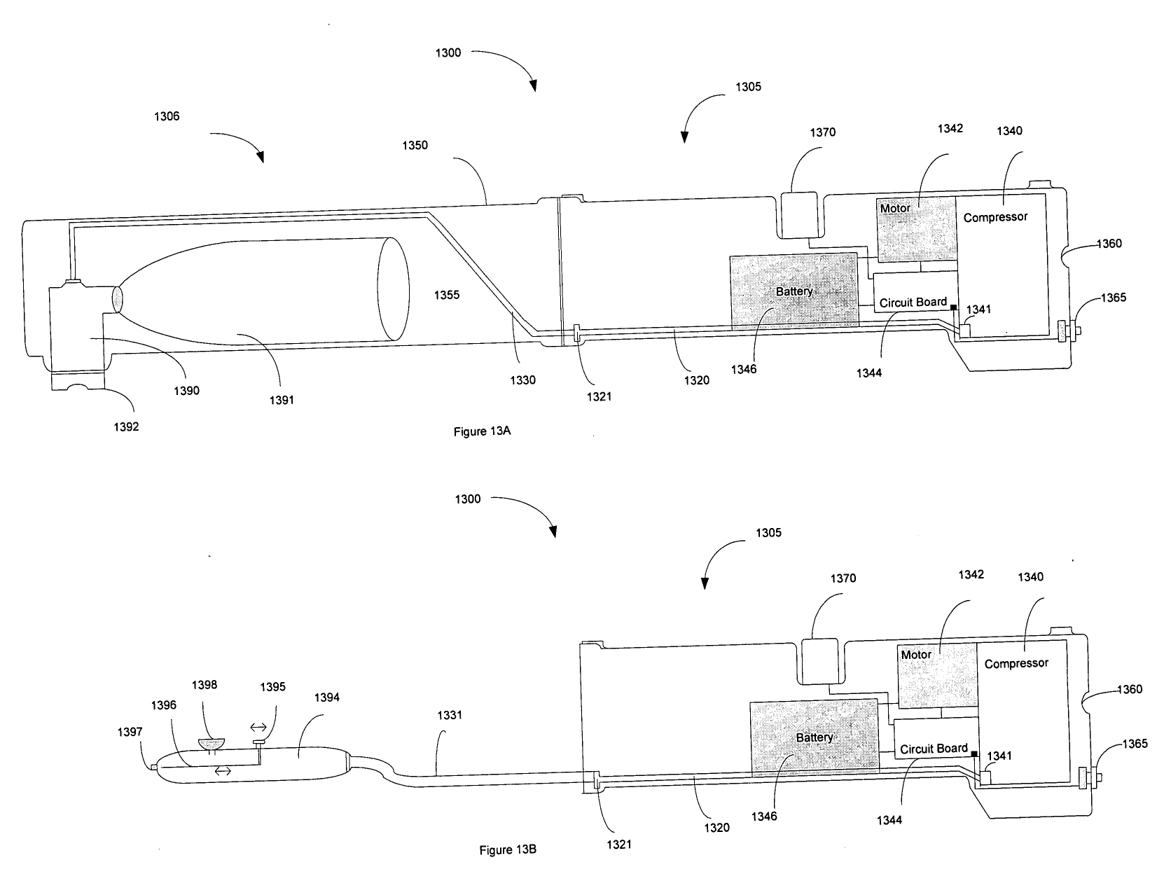

FIGS. 12A and 12B are diagrammatic illustrations of another embodiment of a solution dispensing apparatus 1200 that features a folding handle 1205. Apparatus 1200 generally comprises handle 1205 and an elongate wand 1206. Handle 1205 may include any one or more of various actuation mechanisms described above. Wand 1206 includes a receptacle 1250 suitably dimensioned for receiving an aerosol canister 1280 therein and includes an elongate arm 1290 or other mechanism for actuating a depressible cap 1281 or other dispensing mechanism of canister 1280. In general, handle 1205 preferably includes a trigger 1270 that actuates a displacement mechanism for displacing aerosol canister 1280 within wand 1206. In the present example, handle 1205 is rotatably coupled with wand 1206 by a coupling device 1225, such as a pin connector or other suitable fastener. Accordingly, handle 1205 may be rotated as shown in the diagrammatic illustration of apparatus 1200 in FIG. 12B to facilitate storage and carrying of apparatus 1200. An actuator 1235 may be disposed within handle 1205 that is activated by depression of trigger 1270 that acts to displace canister 1280 within wand 1250 and into abutment with elongate arm 1290. Actuator 1235 may be mechanically, electrically, electro-mechanically, or otherwise coupled with trigger 1270.

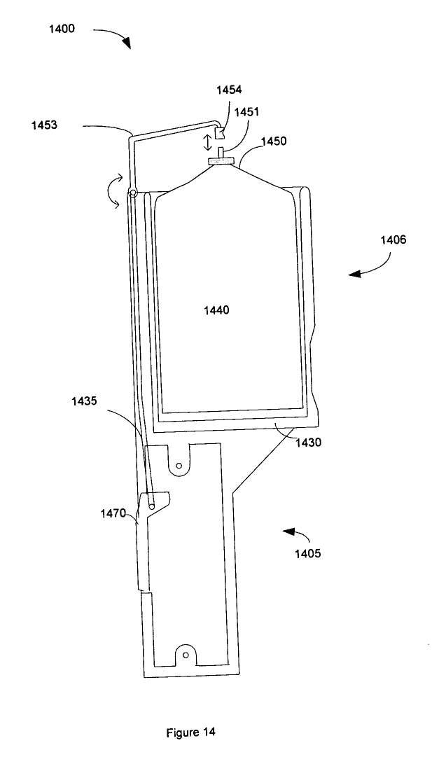

FIG. 13A is a diagrammatic illustration of another embodiment of a solution dispensing apparatus 1300 featuring an integrated compressor 1340. Apparatus 1300 generally comprises handle 1305 and a removable elongate wand 1306. Handle 1305 may include an electro-mechanical actuation mechanism for dispensing a solution from wand 1306. In the illustrative example, an electrical motor 1342 is connected with a battery 1346, compressor 1340 and a circuit board 1344. Circuit board 1344 is driven by battery 1346 coupled thereto. A trigger 1370 is connected with circuit board 1344 for supplying an activation signal to circuit board 1344. An air duct 1320 is connected with an output port 1341 of compressor 1340 and to an interconnect 1321. Handle 1305 may include a recharge port 1360 that is connected with battery 1346 and that may be connected with a power supply for recharging battery 1346. A switch 1365 may be depressed to disable/enable apparatus 1300.

Wand 1306 includes an air duct 1330, such as a rigid conduit or other tubing. Wand 1350 comprises a cavity 1355 in which a solution dispensing assembly may be inserted. In the illustrative embodiment, the solution dispensing assembly comprises a valve device 1390 that is interconnected with a solution bladder 1391 and a nozzle 1392. Valve device 1390, solution bladder 1391, and nozzle 1392 may be monolithically fabricated. In other embodiments, valve device 1390 and nozzle 1391 may be monolithically fabricated and bladder 1391 may be attached thereto, for example by a user or by an assembly person or mechanism at a manufacturer. In this manner, the solution dispensing assembly may be inserted in a single step into cavity 1355. In other embodiments, valve device 1390, bladder 1391, and nozzle 1392 may be individually fabricated and later assembled prior to insertion into wand 1306.

In operation, the solution dispensing assembly is loaded into cavity 1355 by inserting bladder 1391 into cavity 1355 and connecting valve device 1390 with duct 1330. Duct 1330 is connected with interconnect 1321, and wand 1306 is then connected with handle 1305. For example, handle 1305 and wand 1306 may connect by threaded fasteners, snap fasteners, clamps, or by other suitable fasteners.

Apparatus 1300 is activated by depression of trigger 1370. An actuation signal is transmitted to circuit board 1344 in response to depression of trigger 1370. In response to receipt of the actuation signal, circuit board 1344 actuates motor 1342 that, in turn, drives compressor 1340. Compressor 1340 then drives air through an air duct 1320 that passes into duct 1330. On entry of air into valve device 1390, solution from bladder 1391 is drawn therefrom and is intermixed with the air. For example, valve device 1390 may be constructed to produce a venturi effect such that passage of air therethrough results in a pressure drop that draws air from bladder 1391. An air and solution mixture is then discharged from nozzle 1392.

The functional capability of apparatus 1300 may be modified by removing wand 1306 and connecting a flexible hose 1331 with interconnect 1321 as shown by the diagrammatic illustration in FIG. 13B of solution dispensing apparatus 1300 configured for use in an airbrush assembly. Hose 1331 connects with an input of an airbrush 1394. Airbrush 1394 includes a solution dispensing nozzle 1397 and a valve linkage 1396. Valve linkage 1396 is connected with a trigger 1395. A cosmetic or other solution may be filled in receptacle 1398 that feeds into airbrush 1394. When compressor 1340 is activated, air is driven into airbrush 1394. When the user activates airbrush 1394 by sliding trigger 1395, valve linkage 1396 opens nozzle 1397 and solution from receptacle 1398 is dispensed from dispensing nozzle 1397.

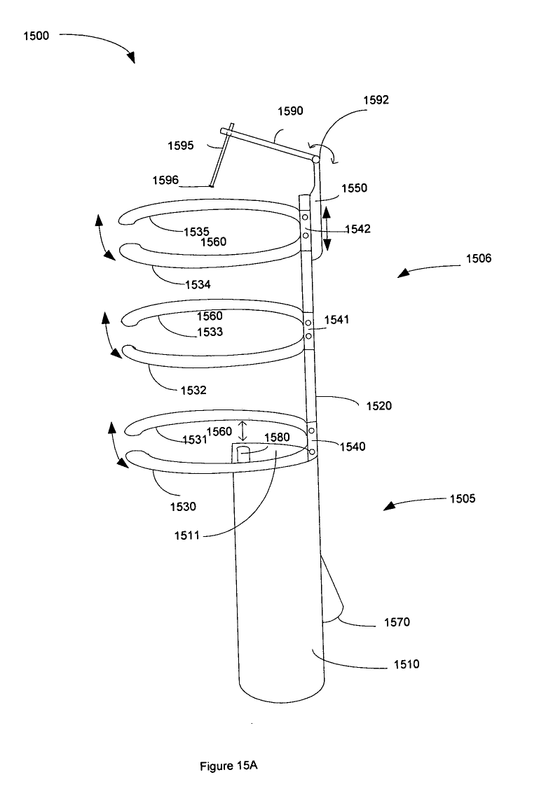

FIG. 14 is a diagrammatic representation of another embodiment of a solution dispensing apparatus 1400 that includes an nozzle integrated with apparatus 1400. Apparatus 1400 includes a handle 1405 and an elongate wand 1406. Wand 1406 includes a cavity 1440 for holding an aerosol canister 1450. Canister 1450 has a valve stem 1451 through which a solution contained therein may be dispensed. Handle 1405 includes a trigger 1470 that is coupled with a linkage 1435. Linkage 1435 interconnects with a pivoting actuator member 1453. Actuator member 1453 has a nozzle 1454 connected at a distal end thereof. Actuator member 1453 may be manually rotated to access cavity 1440 for insertion or removal of canister 1450. Once canister 1450 is loaded into apparatus 1400, actuator member 1453 is rotated so that nozzle 1454 engages valve stem 1451 of canister 1450. Once actuator member 1453 is configured so that nozzle 1454 is engaged with valve stem 1451, a user may depress trigger 1470 that displaces linkage 1435. The displacement of linkage 1435 is such that a rotational motion is imparted on actuator member 1453. Rotation of actuator member 1453 results in nozzle 1454 actuating valve stem 1451 and consequent dispensing of solution from canister 1450 through nozzle 1454.

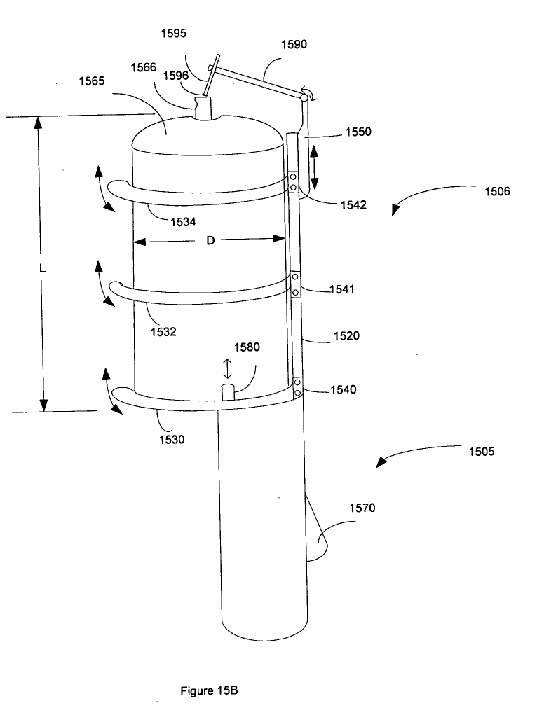

FIG. 15A is a diagrammatic representation of another embodiment of a solution dispensing apparatus 1500 that features an adjustable frame for receiving canisters of differing lengths and heights. Apparatus 1500 includes a handle 1505 and elongate wand 1506. Handle 1505 comprises an extension 1510 having a user depressible trigger 1570 that is linked with an actuation mechanism 1580.

Wand 1506 includes an elongate frame 1520 on which adjustable retainer arms 1530-1535 are coupled. In the illustrative example, retainer arms 1530-1535 are coupled to frame 1520 with respective hinges 1540-1542. Retainer arms 1530-1535 may generally comprise a semicircular, elliptical, or other arced curvature that facilitates insertion of a canister within a cavity 1560 defined by arms 1530-1535. Hinged couplings of retainer arms 1530-1535 with frame 1520 allows apparatus 1500 to accommodate canisters of various diameters (D). An extensible mount 1550 is slideably coupled with frame 1520. An elongate arm 1590 is rotatably coupled to extensible mount 1550 by a pin coupling 1592 or other suitable fastener that allows rotation of elongate arm 1590 about the coupling. Pin coupling 1592 also allows locking of elongate arm 1590 into a desired position. A depression element 1595 is connected at a distal end of elongate arm 1590.

In operation, elongate arm 1590 is rotated clockwise to provide clearance for insertion of a canister within cavity 1560 defined by retainer arms 1530-1535. Retainer arms 1530-1535 may be rotated outward to expand the allowable diameter of the canister. Once the canister is inserted into apparatus 1500 and the base thereof rests on a top surface 1511 and/or actuation mechanism 1580 of handle 1505, retainer arms 1530-1535 may be rotated inward to clamp or otherwise stabilize the position of the canister within apparatus 1500. Extensible mount 1550 may be adjusted up or down along frame 1520 to suitably position elongate arm 1590 above the canister. Elongate arm 1590 is then rotated into position and locked or otherwise secured such that a distal end 1596 of depression element 1595 abuts or is proximate a nozzle or depressible cap of the canister.

FIG. 15B is a diagrammatic representation of apparatus 1500 having a canister 1565 loaded for solution dispensing. Extensible mount 1550 is adjusted up or down on frame 1520 such that distal end 1596 of depression element 1595 can be positioned approximately a length (L) of the canister above actuation element 1580. Retainer arms 1530-1535 are rotated to clamp or otherwise secure canister 1565 in apparatus 1500. Elongate arm 1590 is then rotated and secured into position such that distal end 1596 of depression element 1595 abuts, or is proximate to, a dispensing cap 1566 of canister 1565. A user then depresses trigger 1570 that drives actuation mechanism 1580 upward. Actuation mechanism 1580 displaces canister 1565 upward within apparatus 1500 and results in depression of dispensing cap 1566 by depression element 1595. Solution within canister 1565 is then ejected from dispensing cap 1566.

The various embodiments of the solution dispensing apparatus may be constructed of a light-weight and sturdy material such as metal or plastic. The dimensions and profile of the apparatus are such that it is easy for the user to hold and manipulate. In some embodiments, a small and compact air compressor is connectable to the apparatus to generate and supply the needed pressurized air for spraying solution onto a user. A suitable length of flexible tubing (made of vinyl, rubber or plastic) may be used to connect the apparatus and the air compressor.

Although the description herein has emphasized the application of a solution to the user's body, the wand may be used to apply other liquids to any surface and the invention should not be limited to the application of any particular solutions. Moreover, configurations of the various embodiments are intended as examples, and not as an structural limitation of embodiments described herein. Additionally, various features of embodiments shown and described above may be integrated with other described embodiments.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A hand-held elongated wand for dispensing a solution to a user's body, wherein the solution is contained in an aerosol container having a dispensing mechanism, the wand comprising:
a receiving means for attaching the aerosol container to the wand; and
a triggering means coupled to the receiving means for actuating the dispensing mechanism, the triggering means including:
a trigger configured for actuation by a user of the wand;
an engagement mechanism configured for engaging and actuating the dispensing mechanism; and
a linkage mechanism coupling the trigger mechanism to the engagement mechanism, wherein actuation of the trigger by the user results in actuation of the dispensing mechanism.

2. The wand of claim 1 further comprising:
a handle portion containing the trigger; and
an intermediate portion coupled to the receiving means and the handle portion, wherein the intermediate portion abuts the aerosol container held by the receiving means.

3. The wand of claim 1, wherein the receiving means is a partial sleeve.

4. The wand of claim 1, wherein the engagement mechanism is rotatably coupled to the receiving means at a pivot point, wherein movement of the linkage mechanism rotates the engagement mechanism around the pivot point to contact the dispensing mechanism.

5. The wand of claim 4, wherein the engagement means includes an elongate arm configured to depress a cap on the aerosol container.

6. The wand of claim 1, wherein the wand is implemented in an apparatus about ten inches in length.

7. An airbrush system comprising:
an elongate wand having a plurality of segments capable of being connected together or disconnected from one another; and
an airbrush nozzle coupled to each of the plurality of segments of the wand, the airbrush nozzles being in substantial alignment when the plurality of segments are connected together.

8. The system of claim 7, wherein the wand further comprises a telescopic extension.

9. The system of claim 7, wherein the wand further comprises at least one solution storage compartment.

10. The system of claim 7, wherein each segment of the wand comprises a solution storage compartment.

11. The system of claim 7, further comprising a flexible tubing coupling the wand to an air compressor.

12. An airbrush system comprising:
a rigid elongated wand;
a plurality of airbrush nozzles coupled to the wand in substantial linear alignment;
a plurality of switches coupled to the wand, each switch being associated with an airbrush nozzle and operable to activate or disable the airbrush nozzle; and
a storage compartment coupled to the wand for storing a liquid in fluid communication with each of the plurality of airbrush nozzles.

13. The system of claim 12, wherein the wand further comprises a telescopic extension.

14. The system of claim 12, further comprising a flexible tubing coupling the wand to an air compressor.

15. An airbrush system comprising:
a rigid elongated wand;
an airbrush nozzle coupled to a distal end of the wand, the airbrush nozzle having a rotatably positionable neck;
a switch coupled to the wand operable to activate or disable the airbrush; and
a storage compartment coupled to the wand for storing a liquid in fluid communication with the airbrush nozzle.

16. A hand held solution dispensing apparatus, comprising:
a handle including a trigger coupled with a linkage to an actuator mechanism, wherein the trigger is adapted to be actuated by a user;
an elongate wand comprising a receptacle for storing a solution canister and an actuator element; and
a nozzle connected with the wand, wherein the actuator mechanism is displaced in the handle in response to the trigger being depressed, and wherein the displacement is sufficient to abut the actuator mechanism with the canister, displace the canister, and abut a dispensing cap of the canister with the actuator element.

17. The apparatus of claim 16, wherein the wand comprises a slot at a base thereof, and wherein the actuator mechanism includes an extended member that has at least a portion thereof disposed in the slot, and wherein the extended member has a cap connected at an end thereof that is disposed within the receptacle of the wand.

18. The apparatus of claim 17, wherein the cap of the actuator mechanism abuts the canister in response to the trigger being depressed.

19. A hand held solution dispensing apparatus, comprising:
a handle including a battery connected with a motor that is coupled to a compressor having an output port connected with a first duct;
a wand that is removably coupled to the handle and that includes a second duct that is adapted to be coupled with the first duct of the handle, wherein the second duct is removably connectable to a solution dispensing assembly comprising a valve having a nozzle and a solution bladder connected therewith, wherein the solution dispensing assembly is configured to draw solution from the bladder and eject the solution from the nozzle in response to actuation of the compressor in the handle.

20. The apparatus of claim 19, wherein the first duct and the second duct are coupled at a interconnect disposed in the handle.

21. The apparatus of claim 19, wherein the first duct is connected with an interconnect disposed in the handle, and wherein the interconnect is configured to connect with a flexible hose adapted to be connected with an airbrush when the wand is removed from the handle.
